(19) United States
(12) Patent Application Publication
(10) Pub. No.: US 2026/0101909 A1
(43) Pub. Date: Apr. 16, 2026

(54) METHOD FOR PRODUCING MEAT-LIKE PROCESSED FOOD, AND BINDER FOR MEAT-LIKE PROCESSED FOODS

(71) Applicant: FUJI OIL HOLDINGS INC., Osaka (JP)

(72) Inventors: Tomonori SATO, Ibaraki (JP); Hiroko YONEMOTO, Ibaraki (JP)

(73) Assignee: FUJI OIL HOLDINGS INC., Osaka (JP)

(21) Appl. No.: 19/112,975

(22) PCT Filed: Nov. 27, 2023
(86) PCT No.: PCT/JP2023/042381

§ 371 Date: Mar. 19, 2025

(30) Foreign Application Priority Data
Dec. 8, 2022 (JP) 2022-196069

(51) Int. Cl. A23J 3/22; A23L 29/262

(52) U.S. Cl. CPC A23J 3/227; A23L 29/262

(57) ABSTRACT

An object is to provide a method for preparing a meat-like processed food using methylcellulose as a binder for substituting for egg white and using a textured plant protein material as a substitute for livestock meat without requiring use of a cutter or the like having a strong shearing force as essential during preparation thereof. The meat-like processed food can be produced without using a cutter or the like by: (a) mixing methylcellulose with a water-swellable dietary fiber; (b) mixing (a) and water with a textured plant protein material to prepare a dough; and (c) molding a dough prepared in (b), and then heating the molded dough to produce a meat-like processed food.

### TECHNICAL FIELD

The present invention relates to a meat-like processed food using a textured plant protein material as an alternative to livestock meat.

### BACKGROUND ART

The plant food market (particularly, meat-like processed foods such as a veggie burger) has experienced significant growth in Japan and abroad. These meat-like processed foods are foods processed like livestock meat using a textured protein material produced by texturing a plant protein, such as soy protein, as a main raw material using an extruder and/or the like. However, many of such products use dried egg white, which is an animal material, and thus persons who practice complete vegetarianism, so-called vegans, would avoid such foods.

Methylcellulose (hereinafter MC) is frequently used as a substitute material for dried egg white. Patent Document 1 describes a meat-like processed food containing methylcellulose as a body prepared with methylcellulose, gluten, and the like. However, the food fails to exhibit the texture that can be substitute for those with egg white. Patent Document 2 discloses a meat-like processed food in which an insoluble dietary fiber and a citrus fiber are added to an isolated soybean protein material and methylcellulose. According to Patent Document 2, this food can achieve a good yield in heating process and has a meat-like texture, even without using an animal material.

### CITATION LIST

### Patent Documents

Patent Document 1: JP 2005-21163 A
Patent Document 2: JP 7099661 B

### SUMMARY OF INVENTION

### Technical Problem

An object of the present invention is to provide a method for preparing a meat-like processed food using methylcellulose as a binder for substituting for egg white and using a textured plant protein material as an alternative to livestock meat, without essentially requiring use of a cutter or the like having a strong shearing force.

### Solution to Problem

As a result, the present inventors have found that, by mixing methylcellulose with a water-swellable dietary fiber in advance and adding the mixture to a textured soybean protein, a meat-like processed food can be prepared, in which methylcellulose can be dispersed without using a cutter or the like, and which is rich in meat-like texture both during heating and after cooling and has an improved yield during heating.

That is, the present invention relates to the following.

(1) A method for producing a meat-like processed food, the method including:
(a) mixing methylcellulose with a water-swellable dietary fiber;
(b) mixing a mixture of (a), a textured plant protein material, and water; and
(c) molding a dough prepared in (b), and then heating the molded dough to produce a meat-like processed food.

(2) The method for producing a meat-like processed food according to (1), wherein a mass ratio of the methylcellulose to the water-swellable dietary fiber is from 5:1 to 1:7.

(3) The method for producing a meat-like processed food according to (1), wherein a content of the water-swellable dietary fiber in the dough is from 0.05 to 5 mass %.

(4) The method for producing a meat-like processed food according to (1), wherein the water-swellable dietary fiber has a water absorption ratio of 3 times or more.

(5) The method for producing a meat-like processed food according to (1), wherein the water-swellable dietary fiber is a combination of a highly swellable dietary fiber and a low swellable dietary fiber at a ratio of from 1:4 to 4:1.

(6) The method for producing a meat-like processed food according to (1), wherein an oil and/or fat is added during the preparation of the dough.

(7) The method for producing a meat-like processed food according to (1), wherein a mass ratio of the methylcellulose to the water-swellable dietary fiber is from 5:1 to 1:7, a content of the water-swellable dietary fiber in the dough is from 0.05 to 5 mass %, the water-swellable dietary fiber has a water absorption ratio of 3 times or more, the water-swellable dietary fiber is a combination of a highly swellable dietary fiber and a low swellable dietary fiber at a ratio of from 1:4 to 4:1, and an oil and/or fat is added during the preparation of the dough.

(8) The method for producing a meat-like processed food according to (1), wherein a device having a shearing force is not used in steps (a) to (b).

(9) The method for producing a meat-like processed food according to (7), wherein a device having a shearing force is not used in steps (a) to (b).

(10) A binder for a meat-like processed food, containing methylcellulose and a water-swellable dietary fiber, and having a mass ratio of the methylcellulose to the water-swellable dietary fiber of from 5:1 to 1:7.

(11) The binder for a meat-like processed food according to (10), wherein the water-swellable dietary fiber has a water absorption ratio of 3 times or more.

(12) The binder for a meat-like processed food according to (10), wherein the water-swellable dietary fiber is a combination of a highly swellable dietary fiber and a low swellable dietary fiber at a ratio of from 1:4 to 4:1.

(13) The binder for a meat-like processed food according to (11), wherein the water-swellable dietary fiber is a combination of a highly swellable dietary fiber and a low swellable dietary fiber at a ratio of from 1:4 to 4:1.

(14) The binder for a meat-like processed food according to (10), wherein the binder is used for an application free from livestock meat and egg white.

(15) The binder for a meat-like processed food according to (11), wherein the binder is used for an application free from livestock meat and egg white.

(16) The binder for a meat-like processed food according to (12), wherein the binder is used for an application free from livestock meat and egg white.

(17) The binder for a meat-like processed food according to (13), wherein the binder is used for an application free from livestock meat and egg white.

Further, the present invention relates to the following.

(1) A method for producing a meat-like processed food, the method including:
(a) mixing methylcellulose with a water-swellable dietary fiber;
(b) mixing a mixture of (a), a textured plant protein material, and water; and
(c) molding a dough prepared in (b), and then heating the molded dough to produce a meat-like processed food.

(2) The method for producing a meat-like processed food according to (1), wherein a mass ratio of the methylcellulose to the water-swellable dietary fiber is from 5:1 to 1:7.

(3) The method for producing a meat-like processed food according to (1), wherein a content of the water-swellable dietary fiber in the dough is from 0.05 to 5 mass %.

(4) The method for producing a meat-like processed food according to (1), wherein the water-swellable dietary fiber has a water absorption ratio of 3 times or more.

(5) The method for producing a meat-like processed food according to (1), wherein the water-swellable dietary fiber is a combination of a highly swellable dietary fiber and a low swellable dietary fiber at a ratio of from 1:4 to 4:1.

(6) The method for producing a meat-like processed food according to (1), wherein a device having a shearing force is not used in steps (a) to (b).

(7) The method for producing a meat-like processed food according to (1), wherein an oil and/or fat is added during the preparation of the dough.

(8) A binder for a meat-like processed food, containing methylcellulose and a water-swellable dietary fiber, and having a mass ratio of the methylcellulose to the water-swellable dietary fiber of from 5:1 to 1:7.

(9) The binder for a meat-like processed food according to (8), wherein the water-swellable dietary fiber has a water absorption ratio of 3 times or more.

(10) The binder for a meat-like processed food according to (8), wherein the water-swellable dietary fiber is a combination of a highly swellable dietary fiber and a low swellable dietary fiber at a ratio of from 1:4 to 4:1.

(11) The binder for a meat-like processed food according to (8), wherein the binder is used for an application free from livestock meat and egg white.

### Advantageous Effects of Invention

According to the present invention, a meat-like processed food which is rich in meat-like texture both during heating and after cooling and has an improved yield during heating can be provided without using a cutter or the like.

### DESCRIPTION OF EMBODIMENTS

### Meat-Like Processed Food

A meat-like processed food in the present invention refers to a food processed like livestock meat using mainly a textured plant protein material. Examples of the meat-like processed food include hamburgers, patties, meatballs, nuggets, fish or chicken meatballs, hams, sausages, salamis, frankfurters, corn dogs, jiaozi (Chinese dumplings), shumai (Chinese steamed meat dumplings), egg rolls, meat buns, shoronpo (small Chinese dumplings), minced meat cutlets, meat pies, ravioli, lasagna, meat loaf, stuffed cabbage rolls, green peppers stuffed with meat, and other foods usually prepared using minced meat of various types.

### Methylcellulose

The methylcellulose used in the present invention is produced by methoxylation of cellulose, which is widely distributed in nature, as a raw material and is usually produced by treating cellulose with caustic soda and then reacting it with methyl chloride and an etherifying agent. In addition, it exhibits a reversible increase in gelling power upon heating. In an embodiment of the present invention, methylcellulose can be used alone or in combination with an additional gelling agent. Examples of the additional gelling agent include egg white, gellan gum, carrageenan, alginic acid, agar, curdlan, konjac flour, and starch.

### Water-Swellable Dietary Fiber

The water-swellable dietary fiber used in an embodiment of the present invention is a fiber that swells in water or warm water but does not dissolve readily in water or warm water. The water-swellable dietary fiber preferably has a water absorption ratio described below of 3 times or more. The water absorption ratio is preferably 50 times or less and more preferably 45 times or less. In addition, a dietary fiber derived from a plant is preferred.

These water-swellable dietary fibers can be classified into low swellable dietary fibers having a water absorption ratio of less than 15 times and highly swellable dietary fibers having a water absorption ratio of 15 times or more. The low swelling dietary fiber preferably has a water absorption ratio of 14 times or less, 12 times or less, or 10 times or less, and the highly swelling dietary fiber preferably has a water absorption ratio of 20 times or more, 25 times or more, or 30 times or more. Specific examples of the low swellable dietary fiber can include bamboo fiber, sugarcane fiber, apple fiber, potato fiber, pea fiber, oat fiber, and wheat fiber, and specific examples of the highly swellable dietary fiber can include citrus fiber described below. For the effects of the present invention, that is, the effect of imparting moderate hardness to a meat-like processed food without causing dryness and the effect of maintaining hardness after the meat-like processed food is allowed to cool, bamboo fiber, oat fiber, and citrus fiber are particularly preferred.

Furthermore, in an embodiment of the present invention, a plurality of different types of water-swellable dietary fibers having the above-described water absorption ratio can be used in combination. A mixture of the highly swellable dietary fiber and the low swellable dietary fiber at a ratio of from 1:4 to 4:1, preferably from 1:2 to 2:1 is particularly rich in meat-like texture and is therefore preferred.

The citrus fiber used in an embodiment of the present invention is produced by squeezing a citrus fruit, such as an orange, then removing juice from the squeezed liquid, and giving high impact to the cell walls after powdering. Thus, in the citrus fiber, the micellar structure of the cell is destroyed and turned into a porous structure. This significantly improves the water absorption capacity as well as increases the affinity with water, and consequently improves the water holding capacity for the incorporated water. As the citrus raw material, those derived from orange and/or lemon are particularly preferred.

### Water Absorption Ratio

The water absorption ratio is measured by adding 50 g of water to 1 g of a sample fiber, stirring the mixture in a 50-mL volume container, then allowing the mixture to stand undisturbed for 24 hours, and observing a boundary between a supernatant and a precipitate. When the boundary (precipitation amount) is 20 mL, the water absorption ratio is determined as 20 times. When the sample has no observable boundary, it is not classified as a water-swellable dietary fiber.

### Binder

The mixture of the methylcellulose with the water-swellable dietary fiber can be used as a binder substituting for egg white, to bind the textured plant protein materials described below together, thereby producing a meat-like processed food.

The mixing of the methylcellulose with the water-swellable dietary fiber may be carried out at any point during the production, but it is necessary that both components have already been mixed when they are brought into contact with the plant protein material. When they are added separately without mixing or when the mixing is extremely insufficient, the effects of the present invention may not be obtained.

The mass ratio of the mixed methylcellulose to water-swellable dietary fiber is preferably from 5:1 to 1:7. When the methylcellulose is mixed in a large amount, dispersibility may deteriorate and the meat-like texture may not be present. When the methylcellulose is mixed in a small amount, the yield may be poor. The mass ratio is preferably from 4:1 to 1:6, and is more preferably from 1.5:1 to 1:6.

The present binder can be distributed independently as a binder substituting for egg white used in the production of a meat-like processed food. The content of each component present in the binder can be set to any value, but, for example, the water-swellable dietary fiber is preferably added into the dough of the meat-like processed food at a content of from 0.05 to 5 mass %. Other components may be mixed within a range that exerts no effect on the production of the meat-like processed food.

The meat-like processed food using the binder preferably does not contain animal raw materials such as livestock meat and egg white. The present invention is characterized in that a meat-like processed food can be produced in which these animal raw materials are reduced or not used.

### Textured Plant Protein Material

The textured plant protein material used in an embodiment of the present invention is a material that has a water-insoluble tissue with directionality and is mainly composed of plant protein. Specific examples include those produced by processing a plant raw material whose main ingredient is protein into a textured form, the plant raw material exemplified by soybean, defatted soybean, soy protein isolate, soy protein concentrate, wheat, wheat protein, pea, pea protein, chickpea, and mycoprotein. Examples of the textured plant protein material processed from soybean include materials in a form of granules, flakes, or sliced meat, produced by blending soybean, defatted soybean, soy protein isolate, and/or the like together with an additional raw material if necessary, and texturing the mixture using a single-screw or twin-screw extrusion machine (extruder) and/or the like under high temperature and high pressure. Also, for pea, mung bean, or chickpea, the textured material can be produced by applying a similar treatment to a fraction containing a large amount of protein, such as a fractionated product, used as a raw material. These raw materials have a protein concentration preferably of 50 mass % or more and more preferably of 60 mass % or more.

For an embodiment of the present invention, a textured soybean protein material containing soybean as a main raw material is suitable, and a product with any shape and size can be appropriately selected and used according to a desired product form. Although some products are distributed after rehydration, a dried product (water content of 10 mass % or less) is preferably used in an embodiment of the present invention. In addition, a soybean material textured by pressing tofu is also suitable for an embodiment of the present invention.

A material known as a gluten chip, prepared by processing wheat protein, can also be used as the textured plant protein material in an embodiment of the present invention.

Oil and/or Fat

An oil and/or fat of various types can be used in the meat-like processed food according to an embodiment of the present invention. Specific examples include soybean oil, rapeseed oil, rice oil, corn oil, palm oil, beef tallow, pork fat, and fractionated oils, hydrogenated oils, and interesterified oils of these, and these can be appropriately selected and used. However, the object of the present invention is a meat-like processed food, and thus an oil and/or fat that is in a melted state at a temperature when consumed or at an oral temperature is preferably used. An oil and/or fat having no fluidity at 15° C. is more preferred because the timing of addition during dough preparation described below is less likely to be subjected to restrictions when such an oil and/or fat is used.

### Device Having Shearing Force

In an embodiment of the present invention, the “device having a shearing force” is an apparatus which applies a strong shearing force (shear) to an object to cut and mix the object, and is referred herein as an apparatus the present invention does not actively seek its use. The device having a shearing force is also called a cutter or the like, and examples thereof can include a silent cutter, a food cutter, a cutter mixer, a food processor, and a Stefan mixer. Even a producer who is not equipped with the device having a shearing force can appropriately disperse methylcellulose and obtain a processed food having a good texture, by employing an embodiment of the present invention.

A method for producing a meat-like processed food using the product of the present invention will be described below.

Step (a): Mixing of Methylcellulose with Water-Swellable Dietary Fiber

A mixed powder is prepared by mixing dry powders of methylcellulose and a water-soluble dietary fiber. The mixing ratio is as described above, and two or more types of raw materials are powder-mixed by various methods. Specific examples of the mixing method include, but are not limited to, methods using a mixer such as a cutter mixer, a ribbon mixer, a screw mixer, a V-type mixer, or a W-cone mixer.

The mixed powder can be distributed independently as a binder for a meat-like processed food.

Step (b): Mixing of (a) with Textured Plant Protein Material

A textured plant protein material and the above-described mixed powder are added in a mixer or the like, specifically in a stirring apparatus such as a Kenwood mixer, a paddle mixer or a ribbon mixer. Since the textured plant protein material is usually in a dry state, it is preferably subjected to “rehydration,” in which the material is allowed to absorb water, thereby softening its texture, before the operation described above is performed. A dry-state textured plant protein material or partially rehydrated textured plant protein material can also be used.

After the addition of the mixed powder to the textured plant protein material, or simultaneously with the addition of the mixed powder, water can be further added as required. Alternatively, the textured plant protein material may be added after a part or all of the water is added to the mixed powder. The content of the textured plant protein material is preferably from 5 to 30 mass % and more preferably from 8 to 20 mass %, in terms of dry matter, in the water-containing dough. When the water used is cold water at from 0 to 10° C., the meat-like processed food as the final product becomes hard and has an improved texture.

After mixing these raw materials, the mixture is usually stirred for about from 1 to 5 minutes depending on the scale to obtain a dough. During this stirring operation, the use of a strong shear with the above-described cutter or the like is not encouraged and not necessary.

Addition of Oil and/or Fat and Other Raw Materials

During or after the preparation of the dough described above, an oil and/or fat and the like can be added as necessary. The flavor and texture are improved by addition of the oil and/or fat. The content of the oil and/or fat used is preferably from 1 to 20 mass %, and more preferably from 3 to 15 mass % in the dough. When an oil and/or fat having no fluidity at 15° C. is used, the oil and/or fat can be added at the same time as other dough raw materials during the preparation of the dough, which is more preferred. In the case of a liquid oil, it must be added after the other dough raw materials have been mixed in advance.

To give a variation in the flavor and/or physical properties, a seasoning of various types, a vegetable, starch, a gelling agent, another dietary fiber, a plant protein material such as powdered soy protein, or the like can be added as a raw material to the dough. In this case, animal raw materials such as livestock meat and egg white are preferably not contained.

### Step (c): Molding and Heating

The dough prepared in step (b) is molded into a desired size and shape with a molding machine. Refrigeration or freezing of the dough after molding hardens the meat-like processed food as the final product and improves the texture. Freezing is particularly effective. For example, freezing treatment at −30° C. for about 1 hour can be exemplified.

This is then subjected to heating. In an embodiment of the present invention, baking heating, steaming heating, boiling heating, frying heating, electromagnetic wave heating, and the like can be appropriately used in combination. In addition, retort heating can also be used. This solidifies the molded dough by heating and stabilizes the shape.

The temperature and time depend on the shape, mass, and heating method but the examples include: from 180 to 300° C. for 5 to 15 minutes for the baking heating, from 115 to 130° C. for 10 to 60 minutes for the retort heating, and from 75 to 100° C. for 5 to 50 minutes for the steaming heating.

A meat-like processed food using the binder substituting for egg white can be obtained by the above operation.

### EXAMPLES

Hereinafter, the present invention is described by way of examples. The following parts are parts by mass and % is mass %.

### Study with Highly Swellable Dietary Fiber (Examples 1 to 4 and Comparative Examples 1 and 2)

Methylcellulose (BENECEL MX, available from Ashland Japan Ltd.) and citrus fiber (Herbacel AQ Plus CF-D/100/water absorption rate: 40 times, available from Sumitomo Pharma Food & Chemical Co., Ltd.) were mixed in a plastic bag according to the formulation shown in Table 1 to prepare a mixed powder having each mixing ratio.

Textured soybean protein materials APEX 650 and APEX 350 (both available from Fuji Oil Co., Ltd.) were rehydrated according to the formulation shown in Table 1, the mixed powder was added thereto, water was further added thereto, and the mixture was stirred with a Kenwood mixer for 3 minutes. In Comparative Examples 1 and 2, methylcellulose or citrus fiber was used alone instead of the mixed powder.

Further, solid fat (Unishort MJ available from Fuji Oil Co., Ltd.), vegetables (finely chopped onion), and seasonings and spices were added, and the mixture was further stirred for 1 minute to prepare a dough.

The dough was punched and molded into a 70-g piece using an automatic molding machine (GM-D) available from Nippon Career Industry and then baked by heating at 300° C. for 5 minutes using a convection oven (SCC WE 101 available from Rational Japan Co., Ltd.) to produce a hamburger-like food.

TABLE 1
Study with citrus fiber

| | | | Example | Example | Example | Example | Comparative | Comparative |
|---|---|---|---|---|---|---|---|---|
| | | | 1 | 2 | 3 | 4 | Example 1 | Example 2 |
| | Formulation (parts by mass) | | | | | | | |
| | Methylcellulose | | 1 | 1 | 1 | 1 | 1 | |
| | Citrus fiber | | 1 | 0.5 | 0.3 | 0.1 | | 2 |
| | Added water amount | | 14 | 14 | 14 | 14 | 14 | 14 |
| | APEX 650 | | 6 | 6 | 6 | 6 | 6 | 6 |
| {open oversize bracket} | Rehydration | | 30 | 30 | 30 | 30 | 30 | 30 |
| | water | | | | | | | |
| | APEX 350 | | 10 | 10 | 10 | 10 | 10 | 10 |
| {open oversize bracket} | Rehydration | | 30 | 30 | 30 | 30 | 30 | 30 |
| | water | | | | | | | |
| | Solid fat | | 10 | 10 | 10 | 10 | 10 | 10 |
| | Vegetable | | 10 | 10 | 10 | 10 | 10 | 10 |
| | Seasoning and spice | | 8.7 | 8.7 | 8.7 | 8.7 | 8.7 | 8.7 |
| | Total | | 120.7 | 120.2 | 120.0 | 119.8 | 119.7 | 120.7 |
| | Evaluation | | | | | | | |
| | Heating yield (mass %) | | 83.4 | 81.7 | 81.5 | 81.0 | 81.1 | 83.8 |
| | Texture | Hardness after | 3 | 3 | 2 | 2 | 2 | 1 |
| | | heating | | | | | | |
| | | Meat-like | 3 | 3 | 3 | 2 | 1 | 1 |
| | | texture after | | | | | | |
| | | heating | | | | | | |
| | | Hardness after | 3 | 3 | 2 | 2 | 1 | 1 |
| | | cooling | | | | | | |
| | | Meat-like | 4 | 3 | 3 | 2 | 1 | 1 |
| | | texture after | | | | | | |
| | | cooling | | | | | | |

| | | | | | | |
|---|---|---|---|---|---|---|
| Total score | 13 | 12 | 10 | 8 | 5 | 4 |
| Overall evaluation | 3 | 3 | 3 | 2 | 1 | 1 |

### Evaluation

The mass of each molded dough was measured before and after the molded dough was heated, and the heating yield (mass %) was determined as a value obtained by dividing the mass after heating the molded dough by the mass before heating the molded dough. In addition, sensory evaluation was performed at two points: when a product temperature was about from 50 to 60° C. immediately after the molded dough was heated and baked (after heating the molded dough); and when a product temperature was about from 30 to 40° C. after the product was allowed to stand at ordinary temperature for 20 minutes or more (after cooling the product); each according to the following criteria.

### Sensory Evaluation Criteria

The sensory evaluation was performed by five skilled panelists, and the processed meat food-likeness, in particular, the hamburger-like texture, was comprehensively evaluated and determined by joint consultation. A product with a score of 3 or more in each criterion was rated as acceptable.

### Hardness

The initial hardness in the mouth was defined as follows.
5: Sufficiently hard initial bite
4: Hard initial bite
3: Slightly soft initial bite
2: Soft initial bite
1: Very soft initial bite

### Meat-Like Texture

Meat patty (hamburger)-like loosening feeling perceived from the middle to the latter phase of chewing was defined as meat-like texture as follows.
5. Exhibiting almost no stickiness, exhibiting strong loosening feeling and being rich in granular feeling of meat
4. Exhibiting less stickiness, exhibiting loose feeling and also granular feeling of meat
3. Exhibiting slight stickiness and slightly weak loosening feeling
2. Exhibiting strong stickiness and weak loosening feeling
1. Exhibiting very strong stickiness and weak loosening feeling

### Overall Evaluation

1: Total score of from 4 to 6: Unsuitable
2: Total score of from 7 to 9: Slightly inferior but usable
3: Total score of from 10 to 13: Usable
4: Total score of from 14 to 17: Good
5: Total score of from 18 to 20: Particularly good

As shown in the lower part of Table 1, the combinations of methylcellulose and citrus fiber could prepare a meat-like processed food. However, the result of Example 4 in which the content of citrus fiber was 1/10 of that of methylcellulose was slightly inferior. The Comparative Examples in which methylcellulose or citrus fiber was used alone were both evaluated as unsuitable.

### Study with Low Swellable Dietary Fiber (Examples 5 to 10 and Comparative Examples 3 and 4)

Hamburger-like foods were prepared (Examples 5 to 10) in the same manner as in Example 1, with the formulation shown in Table 2, except that citrus fiber was replaced with bamboo fiber. The bamboo fiber used was BAF90/average fiber length: 80 μm/water absorption rate: 4.5 times, available from Rettenmaier.

“Post-addition” in Comparative Example 3 means that a hamburger-like food was prepared in the same manner as in Example 1, with the formulation shown in Table 2, except that step (a) was not carried out, and only methylcellulose was added, instead of the mixed powder, to the textured plant protein material in step (b), the mixture was stirred with a Kenwood mixer for 3 minutes, and then the bamboo fiber was added together with solid fat and the like. “Pre-addition” in Comparative Example 4 means that a hamburger-like food was prepared in the same manner as in Comparative Example 3 except that step (a) was not carried out, the bamboo fiber was added in step (b), the mixture was stirred with a Kenwood mixer for 3 minutes, and then methylcellulose was added together with solid fat and the like.

TABLE 2
Study with bamboo fiber

| | | | | | | | | | Comparative | Comparative |
|---|---|---|---|---|---|---|---|---|---|---|
| | | | Example 5 | Example 6 | Example 7 | Example 8 | Example 9 | Example 10 | Example 3 | Example 4 |
| | Formulation (parts by mass) | | | | | | | | | |
| | Method for adding | | Mixing | Mixing | Mixing | Mixing | Mixing | Mixing | Post- | Pre- |
| | dietary fiber | | | | | | | | addition | addition |
| | Methylcellulose | | 1 | 1 | 1 | 1 | 1 | 1 | 1 | 1 |
| | Bamboo fiber | | 1 | 2 | 3 | 0.5 | 0.3 | 0.1 | 3 | 3 |
| | Added water amount | | 14 | 14 | 14 | 14 | 14 | 14 | 14 | 14 |
| | APEX 650 | | 6 | 6 | 6 | 6 | 6 | 6 | 6 | 6 |
| {open oversize bracket} | Rehydration | | 30 | 30 | 30 | 30 | 30 | 30 | 30 | 30 |
| | water | | | | | | | | | |
| | APEX 350 | | 10 | 10 | 10 | 10 | 10 | 10 | 10 | 10 |
| {open oversize bracket} | Rehydration | | 30 | 30 | 30 | 30 | 30 | 30 | 30 | 30 |
| | water | | | | | | | | | |
| | Solid fat | | 10 | 10 | 10 | 10 | 10 | 10 | 10 | 10 |
| | Vegetable | | 10 | 10 | 10 | 10 | 10 | 10 | 10 | 10 |
| | Seasoning and spice | | 8.7 | 8.7 | 8.7 | 8.7 | 8.7 | 8.7 | 8.7 | 8.7 |
| | Total | | 120.7 | 121.7 | 122.7 | 120.2 | 120.0 | 119.8 | 122.7 | 122.7 |
| | Evaluation | | | | | | | | | |
| | Heating yield (mass %) | | 81.3 | 82.9 | 81.7 | 81.5 | 81.2 | 81.1 | 81.0 | 82.4 |
| | Texture | Hardness | 4 | 5 | 5 | 3 | 3 | 2 | 3 | 1 |
| | | after heating | | | | | | | | |
| | | Meat-like | 4 | 5 | 5 | 4 | 3 | 2 | 1 | 1 |
| | | texture after | | | | | | | | |
| | | heating | | | | | | | | |
| | | Hardness | 4 | 4 | 4 | 3 | 3 | 2 | 2 | 1 |
| | | after cooling | | | | | | | | |
| | | Meat-like | 4 | 4 | 5 | 3 | 2 | 2 | 1 | 1 |
| | | texture after | | | | | | | | |
| | | cooling | | | | | | | | |

| | | | | | | | | |
|---|---|---|---|---|---|---|---|---|
| Total score | 16 | 18 | 19 | 13 | 11 | 8 | 7 | 4 |
| Overall evaluation | 4 | 5 | 5 | 3 | 3 | 2 | 1 | 1 |

The results are presented in the lower part of Table 2. The combinations of methylcellulose and bamboo fiber could prepare a meat-like processed food similarly as in the case of using citrus fiber. Especially, Examples 6 and 7 in which the bamboo fiber was added at a content of from 2 to 3 times the content of methylcellulose were particularly received particularly good evaluation results. On the other hand, the result of Example 10 in which the content of bamboo fiber was 1/10 of that of methylcellulose was slightly inferior. Comparative Examples 3 and 4 in which methylcellulose and bamboo fiber were added in separate stages without being mixed were both evaluated as unsuitable.

### Study on Simultaneous Use of Highly Swellable Dietary Fiber and Low Swellable Dietary Fiber Examples 11 to 14

Hamburger-like foods were prepared (Examples 11 to 14) in the same manner as in Example 1, with the formation shown in Table 3, except that, in order to observe the effect of combined use of two types of water-swellable fibers, a mixed powder was prepared by further adding a bamboo fiber to the citrus fiber of Example 1.

Table 3. Study with Mixture of Citrus Fiber and Bamboo Fiber

TABLE 3
Study with mixture of citrus fiber and bamboo fiber

| | | Example | Example | Example | Example |
|---|---|---|---|---|---|
| Formulation (parts by mass) | | 11 | 12 | 13 | 14 |
| Methylcellulose | | 1 | 1 | 1 | 1 |
| Bamboo fiber | | 1 | 1 | 1.5 | 2 |
| Citrus fiber | | 2 | 1 | 3 | 4 |
| Added water amount | | 14 | 14 | 14 | 14 |
| | APEX 650 | 6 | 6 | 6 | 6 |
| {open oversize bracket} | | | | | |
| | Rehydration water | 30 | 30 | 30 | 30 |
| | APEX 350 | 10 | 10 | 10 | 10 |
| {open oversize bracket} | | | | | |
| | Rehydration water | 30 | 30 | 30 | 30 |

| | | | | |
|---|---|---|---|---|
| Solid fat | 10 | 10 | 10 | 10 |
| Vegetable | 10 | 10 | 10 | 10 |
| Seasoning and spice | 8.7 | 8.7 | 8.7 | 8.7 |
| Total | 122.7 | 121.7 | 124.2 | 125.7 |

Evaluation

| Heating yield (mass %) | | 84.7 | 83.4 | 85.1 | 85.3 |
|---|---|---|---|---|---|
| Texture | Hardness after heating | 5 | 5 | 5 | 4 |
| | Meat-like texture after | 5 | 5 | 5 | 5 |
| | heating | | | | |
| | Hardness after cooling | 5 | 4 | 5 | 5 |
| | Meat-like texture after | 5 | 4 | 5 | 5 |
| | cooling | | | | |

| | | | | |
|---|---|---|---|---|
| Total score | 20 | 18 | 20 | 19 |
| Overall evaluation | 5 | 5 | 5 | 5 |

The results are presented in the lower part of Table 3. The combinations of citrus fiber, bamboo fiber and methylcellulose were very highly evaluated.

### INDUSTRIAL APPLICABILITY

When the present invention is used, a meat-like processed food or the like using methylcellulose as an egg white substitute can be produced without using a cutter or the like. Therefore, the meat-like processed food or the like can be produced in many places without such facilities.

1. A method for producing a meat-like processed food, the method comprising:
(a) mixing methylcellulose with a water-swellable dietary fiber;
(b) mixing a mixture of (a), a textured plant protein material, and water; and
(c) molding a dough prepared in (b), and then heating the molded dough to produce a meat-like processed food.

2. The method for producing a meat-like processed food according to claim 1, wherein a mass ratio of the methylcellulose to the water-swellable dietary fiber is from 5:1 to 1:7.

3. The method for producing a meat-like processed food according to claim 1, wherein a content of the water-swellable dietary fiber in the dough is from 0.05 to 5 mass %.

4. The method for producing a meat-like processed food according to claim 1, wherein the water-swellable dietary fiber has a water absorption ratio of 3 times or more.

5. The method for producing a meat-like processed food according to claim 1, wherein the water-swellable dietary fiber is a combination of a highly swellable dietary fiber and a low swellable dietary fiber at a ratio of from 1:4 to 4:1.

6. The method for producing a meat-like processed food according to claim 1, wherein an oil and/or fat is added during the preparation of the dough.

7. The method for producing a meat-like processed food according to claim 1, wherein a mass ratio of the methylcellulose to the water-swellable dietary fiber is from 5:1 to 1:7, a content of the water-swellable dietary fiber in the dough is from 0.05 to 5 mass %, the water-swellable dietary fiber has a water absorption ratio of 3 times or more, the water-swellable dietary fiber is a combination of a highly swellable dietary fiber and a low swellable dietary fiber at a ratio of from 1:4 to 4:1, and an oil and/or fat is added during the preparation of the dough.

8. The method for producing a meat-like processed food according to claim 1, wherein a device having a shearing force is not used in steps (a) to (b).

9. The method for producing a meat-like processed food according to claim 7, wherein a device having a shearing force is not used in steps (a) to (b).

10. A binder for a meat-like processed food, the binder comprising methylcellulose and a water-swellable dietary fiber, and having a mass ratio of the methylcellulose to the water-swellable dietary fiber of from 5:1 to 1:7.

11. The binder for a meat-like processed food according to claim 10, wherein the water-swellable dietary fiber has a water absorption ratio of 3 times or more.

12. The binder for a meat-like processed food according to claim 10, wherein the water-swellable dietary fiber is a combination of a highly swellable dietary fiber and a low swellable dietary fiber at a ratio of from 1:4 to 4:1.

13. The binder for a meat-like processed food according to claim 11, wherein the water-swellable dietary fiber is a combination of a highly swellable dietary fiber and a low swellable dietary fiber at a ratio of from 1:4 to 4:1.

14. The binder for a meat-like processed food according to claim 10, wherein the binder is used for an application free from livestock meat and egg white.

15. The binder for a meat-like processed food according to claim 11, wherein the binder is used for an application free from livestock meat and egg white.

16. The binder for a meat-like processed food according to claim 12, wherein the binder is used for an application free from meat and egg white.

17. The binder for a meat-like processed food according to claim 13, wherein the binder is used for an application free from livestock meat and egg white.
